(19) United States
(12) Patent Application Publication
(10) Pub. No.: US 2026/0134195 A1
(43) Pub. Date: May 14, 2026

(54) SYSTEM AND METHOD FOR ARTIFICIAL INTELLIGENCE (AI) POWERED POST-PRODUCTION PROCESSING OF CONTENT

(71) Applicant: RingCentral, Inc., Belmont, CA (US)

(72) Inventors: Sushant Shivram Hiray, Redwood City, CA (US); Ravi Kalluri, San Jose, CA (US); liya Viadimirovich Mikhailov, Saint-Petersourg (RU)

(21) Appl. No.: 18/946,549

(22) Filed: Nov. 13, 2024

(51) Int. Cl. G06F 40/166; G06F 40/20; G06V 20/40; G11B 27/031; G11B 27/34

(52) U.S. Cl. CPC G06F 40/166; G06F 40/20; G06V 20/41; G06V 20/49; G11B 27/031; G11B 27/34

(57) ABSTRACT

A includes receiving a digital data associated with the presentation and detecting a plurality of segments of the presentation. The segments include at least an audio portion, a textual portion, and a video portion. A plurality of transition elements is determined between the plurality of segments of the presentation. A transition element represents a period of time between two consecutive segments. At least one transition element is identified, using a machine learning model, to be modified. The one transition element is between two segments and is modified based on content of the plurality of segments of the presentation.

### BACKGROUND

Recent advancements in online technology and the increase in remote work have increased the usage of collaborative platforms such as video conferencing and webinars as well as other online platforms for presentation purposes. Applications such as PowerPoint® may be used in conjunction with the presenter presenting to an audience and speaking to the content and/or conducting a demo, etc. Recording the presentation and making it available (on-demand) may be useful to those that were not able to attend the meeting/presentation. Some may be interested in only certain aspects of the presentation, e.g., topic/content, demo, etc., and having them navigate the entire recorded content blindly (e.g., by fast forwarding or jumping through the content) or having them to sit through the entire presentation is inefficient and laborious. Moreover, the presentation may suffer from unnecessary pauses, interruptions, long-winded explanations, and/or being too verbose to name a few.

Some have attempted to address some of these issues by manually performing post-processing, e.g., dividing the presentations into chapters, creating a summary/title for each chapter, rerecording certain portions of the presentation to clean up the presentation from being too verbose/long-winded or to remove unnecessary pauses and/or words (e.g., um, ah, like, you know, etc.), etc. Unfortunately, manually post-processing presentations to make it available on-demand is resource/labor intensive and time consuming.

### SUMMARY

Accordingly, a need has arisen to leverage AI to automatically separate out a presentation into segments, provide a short summary or title for each segment, modify the content to remove unnecessary words or reword certain portions to improve the presentation flow, modify the flow of the presentation (e.g., changes from one segment to another), etc.

In some embodiments a computer-implemented method for editing a presentation being made between a presenter and an audience includes receiving a digital data associated with the presentation. The method further includes detecting, in the digital data, a plurality of segments of the presentation, wherein segments of the plurality of segments include at least one or more of an audio portions, a textual portion, and a video portion. According to some embodiments, the method further includes determining a plurality of transition elements between the plurality of segments of the presentation, wherein a transition element of the plurality of transition elements includes at least one or more of a change in the textual portion, a change from a slide to a demonstration, a change within the video portion, a change within the audio portion, a change between the audio portion the textual portion or the video portion, and a change between the presenter and the audience. In one nonlimiting example, the method also includes identifying, using a machine learning model, at least one transition element of the plurality of transition elements to be modified, wherein the at least one transition element is between two segments of the plurality of segments. Moreover, the method includes modifying the at least one transition element based on content of the plurality of segments of the presentation. It is appreciated that the identifying the at least one transition element or the modifying the at least one transition element may be in response to a user indication thereof. In one nonlimiting example, the method may further include rendering the plurality of segments and the plurality of transition elements to the user prior to the user indication thereof.

It is appreciated that in one nonlimiting example, the modifying the at least one transition element based on content of the plurality of segments of the presentation includes generating a new transition element based on content segments of the two segments and replacing the at least one transition element with the new transition element. In one nonlimiting example, the new transition element includes at least one or more of an audio portion, a video portion, and a textual portion. It is appreciated that the modifying includes modifying at least one or more of a textual portion, or a video portion, or an audio portion, of a content of the at least one transition element, according to some examples.

In one nonlimiting example, the method further includes applying another machine learning model to determine the plurality of transition elements. It is appreciated that in yet one nonlimiting example, the plurality of segments is detected by applying a clustering algorithm to the digital data. According to some embodiments, transition elements of the plurality of transitions elements are content positioned between two adjacent segments of the plurality of segments. It is appreciated that in some embodiments, the plurality of segments is detected by applying a natural language processing (NLP) to the digital content.

These and other features and aspects of the concepts described herein may be better understood with reference to the following drawings, description, and appended claims.

### BRIEF DESCRIPTION OF DRAWINGS

FIG. 1A is a system diagram for editing a presentation being made between a presenter and an audience according to some embodiments.

FIG. 1B shows an example of a graphical user interface for segmenting the input data and modifying segments according to some embodiments.

FIG. 2 is a relational node diagram depicting a neural network, in an example embodiment.

FIG. 3 is a flowchart depicting editing a presentation being made between a presenter and an audience, in an example embodiment.

FIG. 4 is a diagram of a processing server, in an example embodiment.

### DETAILED DESCRIPTION

The example embodiments described herein are directed to online technology such as collaborative platforms, webinar, and/or online presentation platforms for presenting content to an audience. The collaborative platform may include a communication system configured to facilitate communication between online users. Communication may be through an online forum, e.g., online group, online team, webinar, chat team, etc. The communication system may also facilitate communication between users via telephony and/or video conferencing, etc.

The communication system such as online collaborative system provides an environment that is configured to facilitate data/content exchanges, e.g., audio data, video data, content data (e.g., PowerPoint®, Word®, PDF, etc.), messaging (e.g., instant messaging), etc., amongst users. It is appreciated that the term “user(s)” generally refers to participants or audience of a communication session whether as host or invitee(s) or team member(s). It is also appreciated that the term “user” is used interchangeably with “member” or “participant” or “audience” throughout the application.

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical, or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying,” “rendering,” “utilizing,” “launching,” “calling,” “starting,” “accessing,” “sending,” “conferencing,” “triggering,” “ending,” “suspending,” “terminating,” “monitoring,” “displaying,” “removing,” “performing,” “preventing,” “hiding,” “blocking,” “tracking,” “associating,” “queuing,” “controlling,” “inserting,” “detecting,” “modifying,” “replacing,” “applying,” “rendering,” or the like, refer to actions and processes of a computer system or similar electronic computing device or processor. The computer system or similar electronic computing device manipulates and transforms data represented as physical (electronic)quantities within the computer system memories, registers or other such information storage, transmission, or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

It is appreciated that the embodiments and examples are provided with respect to a webinar application for illustrative purposes. However, the embodiments should not be construed as limited thereto.

A host or an administrator or any online user (e.g., presenter) may create an online group/team using the communication system. For example, a user may create an online group or team via a chat function of the communication system or via a calendar associated with the online collaborative environment. As another example, a user may create an online group for a webinar using the communication system. It is appreciated that the term “group” or “team” has been used interchangeably throughout the application.

Once an online team has been created (online collaborative environment e.g., Microsoft Teams® account, RingCentral® account, Slack® account, Zoom® account, etc., that may include various applications such as a chat application, video conferencing, audio application, etc.), one or more members of the team can share electronic data/content with other users (i.e. team members) and communicate with one another. For example, a team member (whether the host or presenter or another team member) may present (speak) material as well as share content using applications such as PowerPoint®, Word®, PDF, etc. with other team members or users (also referred to as the audience) during online communication, e.g., messaging, video chat, audio chat, etc.

The shared content with the participants via applications such as PowerPoint®, Word®, PDF, etc., along with the video and/or audio of the presenter may be recorded. Similarly, video and/or audio of the audience may be recorded. In some nonlimiting examples, any content shared by the audience may also be recorded. In other words, the webinar that includes presentation by the presenter, the video and/or audio of the presenter, as well as shared content and/or video or audio of the audience may be recorded. The recorded webinar or presentation may be used later by members that could not have attended the meeting or by participants that were members of the audience but may wish to review the presented content.

In one nonlimiting example, the recorded content (e.g., audio, video, textual, images, etc.) may automatically be divided into segments (e.g., without a person manually having to separate out the content into segments). It is appreciated that dividing the recorded content into segments may be based on a variety of topics that were discussed during the webinar, based on the individual participation of the webinar, based on category in the headings of the PowerPoint® presentation, etc. For example, during the presentation four topics may be discussed and the presentation may be automatically divided into four segments. It is appreciated that the segments may not necessarily be in chronological ordering of their presentation. For example, a first topic may be discussed initially followed by a second topic, third topic, and fourth topic but the first topic may be referred back to in the question-and-answer session. As such, the segments may be formed not necessarily based on the chronological timing but also other factors. In this nonlimiting example, the first topic discussed in the question-and-answer session may be within the same segment as the first topic discussed initially. The segments include one or more of content being presented on, e.g., textual, graphical, demo, video, audio, etc. In one nonlimiting example, clustering algorithms such as K-means clustering, hierarchical clustering, density-based spatial clustering of applications with noise (DBSCAN), Gaussian mixture models (GMM), agglomerative clustering, spectral clustering, mean shift clustering, affinity propagation, etc., may be used to divide the content into segments. In one nonlimiting example, a natural language processing (NLP) may be used to divide the content into segments.

According to some embodiments, one or more transition elements associated with the content is determined using machine learning (ML) and AI. According to some nonlimiting examples, transition elements are elements or content used when transitioning between one segment to the next. For example, a transition element may be content associated with a change in textual portion (such as topic), a change in slide (from one slide to the next), transition of video/audio to another, etc.

As one nonlimiting example, a presenter may be discussing a topic and answering a question from an audience. The video of the presenter may be the first segment followed by the second segment, which may be the video of the audience asking the question followed by the third segment associated with the presenter answering the question. Transition elements may be the content that transitions from the first segment to the second segment to the third segment. In other words, a transition element may be content when transitioning between speakers. In some examples, a transition element may be content associated with a scene change, e.g., change in the background.

As another nonlimiting example, a transition element may be content such as animation used when moving from one slide to the next in PowerPoint® presentation. As yet another example, a transition element may be content associated with presentation when switching from presentation of the slide to demoing a product (e.g., moving from presentation in slide mode to video such as live feed). Another nonlimiting example of a transition element is when switching from the presentation mode, e.g., slides, to showing a video clip. As yet another example, a transition element may be audio content such as a “ding” or sound of the wind indicating moving from one slide to the next or it may be a cue from the presenter such as announcement that a product is now going to be demoed or even music indicating a transition from one segment to the next.

In other words, transition elements are content associated with a change during presentation, e.g., change in content such as textual or images, change in video, change in audio, change from slide presentation to demonstrating product, change from slide presentation to live feed, etc. It is appreciated that transition elements may be part of the original presentation at the time of content being presented to the audience. It is appreciated that a transition element is positioned between two segments, e.g., subsequent segments, segments that are not subsequent to one another, etc.

It is appreciated that one or more of the transition elements may be identified by using AI/ML to be modified. For example, ML may determine that modifying a transition element between two segments may be visually (or audibly or otherwise) more appealing and may automatically modify the transition element or replace it completely. In yet one nonlimiting example, ML may determine that modifying a transition element between two segments may be visually (or audibly or otherwise) more appealing and may flag it, e.g., rendering (visually or audibly), for the user, e.g., presenter, to modify, if the user wishes to comply with the AI/ML suggestion. In one nonlimiting example, the AI/ML may suggest additional transition elements(to the user) to replace the one that was identified for modification, or the user may choose his/her own transition element to replace the old transition element. The suggested additional transition elements may be generated based on the content that was presented and recorded as opposed to a stock transition element that may be unrelated to the content being presented on. In other words, the suggested additional transition elements are customized to flow as part of the content that was presented on and as such will be unnoticeable to a viewer/listener/reader that the content was altered. In response to the user selecting the suggested transition element, the identified transition element is replaced or modified with the suggested transition element.

It is appreciated that AI/ML such as NLP may be used to annotate each segment. For example, a relevant title for each segment may be created and a summary for each segment may be generated.

In some embodiments, the audio portion of the content may be transcribed using a transcription engine such that the content can be processed. For example, processing the transcription of the audio portion may reveal that certain portions of the presentation (e.g., the presenter presenting) were verbose, inaccurate, circular in logic, etc., that could benefit from being reworded. In yet another example, the processing of the transcription may identify filler words that were unnecessary, e.g., “you know”, “like”, “um”, “ah”, etc. In yet another example, AI/ML may identify certain portions of the content that if modified can strengthen the quality of the presentation, e.g., removal of unnecessary pauses, adding pause to increase emphasis on a concept, etc. It is appreciated that in some embodiments, a similar processing may be performed without having to transcribe the audio portion by using NLP.

It is appreciated that processing of the content, e.g., transcribed content, audio processing, video processing, etc., may be used to identify a mismatch between the content being presented on (e.g., talked about) and content being displayed (e.g., slide presentation, video being played, etc.). As such, AI/ML may be used to identify segments containing mismatch and automatically modify the content to address the mismatch. For example, the transcribed content may be indexed as well as the video segments. The AI/ML model may use semantic matching to determine whether there is a mismatch between the transcribed content and the corresponding video segments. Using the indexes for the transcribed content and the video segments, the AI/ML model may automatically modify the synchronization between the transcribed content and the video segments to correct the mismatches between the audio and the video segments.

In yet another example, the identified mismatch between the content being presented on (e.g., talked about) and content being displayed (e.g., slide presentation, video being played, etc.) may be presented to a user to allow the user to take appropriate steps, e.g., modifying the content or having AI/ML modify the content. For example, a presenter may have advanced to a second topic but the slide being displayed is still the content associated with the first topic. Mismatch between the presenter talking about the second topic and the first topic being displayed may be detected and addressed by AI/ML or by the user.

It is appreciated that AI/ML may be used to identify portions that may benefit from being recreated/replaced, e.g., audio, video, text, etc., or from being modified, e.g., removal of certain filler words, removal of a word and replacing it with another word, adding a filler word, modification of video portion, removing a pause, adding a pause, etc. AI/ML may present the user with suggestions on modifications that may be made to strengthen the quality of the presentation by changing the filler words or rewording certain portions of the presentation or by modifying the textual or audio or video portion of the content. The user may choose to approve the suggestion being made by AI/ML (or select from a set of options being provided) and for AI/ML to automatically incorporate the suggestions into the content. In one nonlimiting example, the AI/ML may automatically reword the portions that were identified and/or modify and/or replace the filler words and/or modify audio/video/textual portions of the content.

As one nonlimiting example, rewording a certain portion of the presentation associated with audio portion may use text-to-speech and may utilize voice cloning algorithms such that the modified portion by AI/ML would be indistinguishable from other portions of the presentation. As yet another example, AI/ML may identify the portions for the user, and the user may record (audio, video) or may rewrite a certain portion (e.g., presentation, slide, etc.) associated with the content.

It is appreciated that AI/ML may suggest video clips, once edits to the content is complete. The video clips may be a compilation of content presented on (after edits) that may be used for marketing purposes or to provide a short trailer associated with the presentation to get more subscribers to the presentation or webcast. For example, a short video that may include certain video portions, a short audio that may include certain audio portions, a short textual content from the presentation, etc., may be generated to summarize the content (which may be used for marketing purposes such as a trailer video or to generate a video to increase audience for the generated content by showing a short clip of the presentation and enticing viewers to subscribe to the entire presentation). The video clips may include a short summary associated with the presentation as a whole or a short synopsis associated with one or more segments. In one nonlimiting example, the transcription of the content may be translated to other languages. It is appreciated that translation of the transcription of the content to other languages may be in response to a user selection thereof or may be performed automatically. In yet another nonlimiting example, the audio portion and/or textual portion of the presentation may be translated to other languages, e.g., in response to the user selection thereof or automatically.

It is appreciated that the edited content in its entirely may now be stored with its transcript, subtitles, and additional topics related to the content being presented on. It is appreciated that the video presentation that has been created may further include metadata.

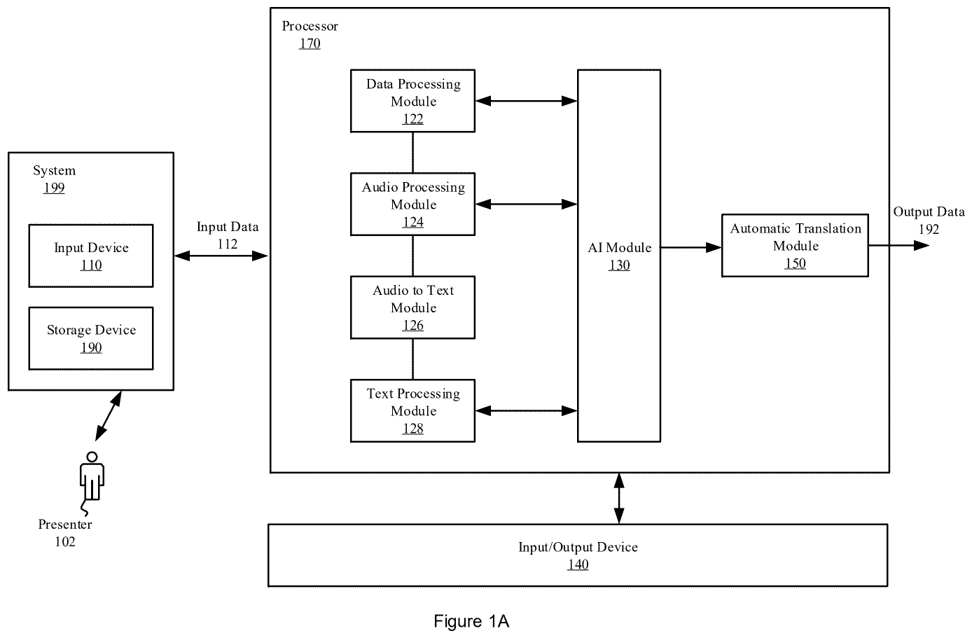

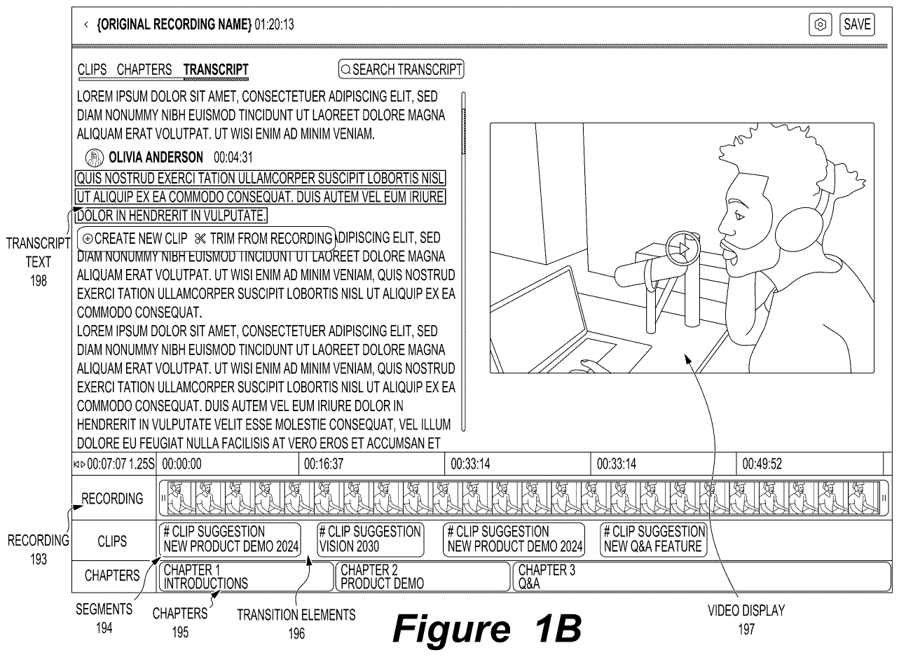

FIG. 1A is a system diagram for editing a presentation being made between a presenter and an audience according to some embodiments. In some nonlimiting examples, the content (e.g., one or more of a slide, video, audio, etc.) may be presented by a presenter 102 to an audience. It is appreciated that the content being presented may include textual portion, video portion, and/or audio portion accompanied with spoken words by the presenter 102 and/or spoken words by the audience, and/or video associated with the presenter 102 and/or audience. For example, the content may be presented using an application such as PowerPoint®, Word®, PDF, etc., and may include textual, audio, and/or video portions accompanied by spoken words and/or video associated with the presenter 102 and/or the audience. The audio and/or video accompanying the content being presented may be captured using an input device 110, e.g., a camera, a microphone, etc., within a system 199 configured to facilitate an online collaborative platform such as video conferencing, audio conferencing, webinar, etc., provided by Microsoft Teams®, RingCentral®, Slack®, Zoom®, etc. The system 199 may be a conferencing system that may include the input device 190. In one nonlimiting example, the system 199 may be a computing device, e.g., a desktop, a laptop, a smartphone, etc., capable of capturing images and audio of the presenter 102 and/or the audience as well as the content, e.g., slides, being presented. It is appreciated that the video/audio accompanying the content being presented by the presenter 102 may be all stored in a storage device 190. The storage device 190 may be within the system 199 or may be external to the system 199. The storage device 190 may include a memory component, e.g., solid-state drive, hard drive, etc.

The content as stored by the storage device 190 may be sent to a processor 170, e.g., a central processing unit (CPU), an application specific integrated circuit (ASIC), a field programmable gate array (FPGA), etc., for processing. The stored content is sent as input data 112 (digital data) to the processor 170 for processing. The processor 170 may include a plurality of processing modules such as data processing module 122, audio processing module 124, audio to text module 126, text processing module 128, an AI module 130, and automatic translation module 150. It is appreciated that the processing modules are shown as separate modules for illustrative purposes and should not be construed as limiting the scope of the embodiments. For example, one module may be configured to perform operations associated with two or more processing modules. Moreover, the processing modules as shown are for illustrative purposes and some of the processing modules may be optional. In other words, the processor 170 may include fewer processing modules with fewer capabilities. Moreover, it is appreciated that processor 170 having the described processing modules may be implemented in a variety of architectures and configurations. For example, the processing modules of the processor 170 may be implemented as part of a distributed computing environment, a cloud computing environment, a client server environment, etc.

According to one nonlimiting example, the data processing module 122 is configured to process the received input data 112, which may include one or more textual content, images, audio portion, video portion, etc., and identify and divide the content of the input data 112 into segments. In this example and for illustration purposes it is assumed that the received input data 112 includes a power point presentation (that includes textual portion, images, video portion, etc.) accompanied with audio/video captured from the presenter 102 presenting to the audience as well as audio/video of the audience. In some nonlimiting examples, the input data 112 further includes data exchanges between the audience and/or the presenter 102, e.g., questions being posed by audience and/or answers being provided by the presenter 102 (in textual format in a chat box or captured by video/audio input device), files being shared by a participant (member of the audience) and/or by the presenter 102, etc.

According to one nonlimiting example, the processing module 122 may divide the input data 112 into segments based on topics that were discussed. For example, the presentation may be regarding ten features of a product that are determined as ten segments. In yet another example, the ten features may be followed by a question/answer portion that may be designated as the eleventh segment. In yet another example, the question/answer portion may be related to the features three, six, and seventh and as such portions of the question/answer related to feature three is associated with the third segment of the presentation whereas portions of the question/answer related to the sixth and seventh features are associated with the sixth and seventh segments respectively. In other words, the segments of the input data 112 may not necessarily be in the chronological ordering of their presentation since certain portions of the question/answer portion toward the end of the presentation may be associated with an earlier segment as an example. In one nonlimiting example, the data processing module 122 may fetch the appropriate ML model from the AI module 130 to divide the input data 112 into segments. For instance, clustering algorithms such as K-means clustering, hierarchical clustering, density-based spatial clustering of applications with noise (DBSCAN), Gaussian mixture models (GMM), agglomerative clustering, spectral clustering, mean shift clustering, affinity propagation, etc., may be used to divide the input data 112 into segments. In one nonlimiting example, a natural language processing (NLP) may be used to divide the content into segments. It is appreciated that different ML models may be used based on the type of data. For example, one ML model may be used for segmenting audio data whereas another ML model may be used for video data whereas, yet another ML model may be used to reconcile the determination made by ML models associated with audio portion and video portion of the data.

In one nonlimiting example, the processing module 122 may divide the input data 112 into segments based on an individual participation in the presentation. For example, in a panel of five discussing a subject, the segments may be associated with each of the panelists. As another example, the segments may be associated with a change in the presentation, e.g., change from presenting slide to showing a video, change from one slide to the next (e.g., under a different heading), change from slide to demoing a product, interactions (transition) between audience members with one another and/or with the presenter 102, change from presenting to playing music, etc. FIG. 1B shows a nonlimiting example of the input data 112, e.g., recording 193, divided into segments 194, e.g., four segments including “New product demo 2024”, “Vision 2030”, “New product demo 2024”, and “New Q&A Feature”. In one nonlimiting example, the segments 194 may be grouped in to chapters 195, e.g., three chapters, e.g., “Chapter 1 Introduction”, “Chapter 2 Product Demo”, and “Chapter 3 Q&A”. Transition elements 196 are positioned between segments 194, as illustrated. According to some nonlimiting examples, the video display 197 may render a video portion of the recordging 193. In one nonlimiting example, the transciprtion text 198 that is a transcript of the audio portion of the input data 112 may be highlighted when a segment from the segments 194 is selected.

In an embodiment/implementation, the data processing module 122 identifies transition elements associated with the segments from the input data 112. Transition elements are elements or content used when transitioning between one segment to the next. For example, a transition element may be content used when transitioning between presenting the first feature of the product and transitioning to present the second feature of the product. The transition element may include one or more of a change in textual/image portion, e.g., a slide introducing the next topic (second feature), a slide associated with the first feature turning into a paper airplane and flying off, a slide associated with the first feature of the product dissolving on page or cutting to illustrate the end of the discussions with respect to the first feature, a slide on the first feature fading, push where the slide on the first feature pushes the new slide into view, the slide on the second feature covering the slide on the first feature in turning a page fashion, etc. It is appreciated that the transition elements may also include a video to reflect a change from one segment to the next, e.g., changing from slide presentation to performing a demo of the product. In yet another example, the transition element may include an audio being rendered, e.g., a “ding” sound, “whoosh” sound, “swoosh” sound, “whip” sound, “bubble” sound, or it may be a cue from the presenter such as announcement that a product is now going to be demoed or even music indicating a transition from one segment to the next, etc., when transitioning from one slide to the next.

It is appreciated that the data processing module 122 may invoke an ML model from the AI module 150 to identify the transition elements. In another nonlimiting example, a transition element may be a clip of the presenter 102 that is inserted in between transitioning from one slide to the next or a live video feed of the presenter 102 being initiated when finishing the first feature and starting the second feature and cutting away from the live video feed to show the slides on the second feature. In some examples, a transition element may be content associated with a scene change, e.g., change in the background. It is appreciated that the examples provided above are non-exhaustive and meant for illustration purposes without limiting the scope of the embodiments.

According to some examples, the transition elements may be part of the original presentation, e.g., slides being presented, and/or the video/audio accompanying the presentation. It is appreciated that a transition element is positioned between two segments, e.g., transition element between features one and two (two adjacent segments), transition element between features one and eight (two segments that are not adjacent to one another), etc.

It is appreciated that the data processing module 122 may identify a transition element from the identified transition elements to be modified. For example, the processing module 122 may utilize an ML model from the AI module 130 to identify a transition element, e.g., transition element between transitioning from second feature of the product to the third feature, that if modified improves the presentation quality, e.g., visually, audibly, comprehensibility, etc., thereby making the presentation more appealing and effective. In one nonlimiting example, the data processing module 122 may automatically modify and/or replace the identified transition element without user manipulation. It is appreciated that the modification of the transition element by the data processing module 122 may be based on the input data 112 as opposed to a stock transition element that may be unrelated to the content being presented on. In other words, the suggested additional transition elements are customized to flow as part of the content (i.e., input data 112) and as such will be unnoticeable to a viewer/listener/reader that the content (or the transition element) was altered.

It is appreciated that in some embodiments, the processor 170 may render the transition element to be modified to a user via the input/output device 140, e.g., a display, a speaker, etc. In other words, the transition element as a candidate for modification is flagged for the user. In one nonlimiting example, the data processing module 122 may further provide suggestions associated with the transition element to be modified, to the user via the input/output device 140, for user selection. In response to the user selection the transition element is modified with the user selection. The user selection may be from the provided suggestions or may be provided by the user independent of the suggestions from the processor 170, e.g., user generated or user input. It is appreciated that the suggestions provided to the user may be generated based on the input data 112 as opposed to a stock transition element that may be unrelated to the content being presented on. In other words, the suggested additional transition elements are customized to flow as part of the content (i.e., input data 112) and as such will be unnoticeable to a viewer/listener/reader that the content (or the transition element) was altered. In response to the user selecting the suggested transition element, the identified transition element is replaced or modified with the suggested transition element.

It is appreciated that identifying a transition element to be modified or replaced is provided for illustration purposes only and should not be construed as limiting the scope of the embodiments. For example, the data processing module 122 may determine that one segment may benefit from being divided into two or more segments and as such may generate transition elements for each segment transition. The generated transition elements and/or the newly segments formed may modify the presentation and as such the input data 112 automatically or may be presented to the user for user selection thereof and thereafter in response to the user selection the modifications, e.g., new segments and newly generated transition elements, may be performed. Accordingly, the presentation (input data 112) as modified becomes more appealing and more effective.

It is appreciated that the audio portion of the input data 112 may be processed by the audio processing module 124. For example, the audio processing module 124 may access an ML model from the AI module 150 to perform NLP on the audio portion of the input data 112. It is appreciated that the processing of the audio portion by the audio processing module 124 as well as processing of the textual portion and/or images of the input data 112 by the data processing module 122 are used to annotate the segments of the input data 112. For example, a relevant title for each segment may be generated, e.g., feature one, feature two, etc. In one nonlimiting example, a short summary associated with each segment may also be generated, as shown in FIG. 1C.

According to some embodiments, the audio portion of the input data 112 may be transcribed into text using an audio to text module 126. As such, the transcription of the audio portion may be processed by the text processing module 128. The text processing module 128 may also use one or more ML models from the AI module 130 to process the transcribed data.

In one embodiment, the audio processing module 124 or the text processing module 128 or a combination thereof may be used to identify one or more portions of the input data 112 that if modified can make the presentation more effective. For example, certain portions of the presentation that are too verbose may be identified. Moreover, certain portions of the presentation that may be inaccurate, circular in logic, etc., may be identified. In yet another example, filler words that are unnecessary, e.g., “you know”, “like”, “um”, “ah”, etc., are identified. In yet another example, AI/ML may identify certain portions of the content that if modified can strengthen the quality of the presentation, e.g., removal of unnecessary pauses, adding pause to increase emphasis on a concept, etc. Accordingly, the identified portions may be automatically modified or may be presented (flagged) to the user via the input/output device 140. In some examples, the identified portions to be modified may be presented along with suggestions on how to modify the content, e.g., removing excessive pause, adding additional pause to increase emphasis, removing filler words, modifying from passive voice to active voice, etc. The user may select from the presented options or may choose to generate an alternative way to address the shortcomings. In response to the user selection the modification may be made. It is appreciated that AI generate suggestions may be based on the input data 112 such that the suggestions use style and language that were used by the presenter 102, thereby customizing to the style of speaking and type of language and sentence structure of the presenter 102, as opposed to a generic suggestion without considering the input data 112.

It is appreciated that in some embodiments, the user may be provided with an option of rerecording, e.g., via a microphone in the input/output device 140, to replace the audio portion that is being modified. In one nonlimiting example, a text-to-speech and voice cloning may be utilized to convert text selected by the user (from the suggestion provide or independently provided by the user) to speech and to clone the presenter's voice to make the presentation indistinguishable from the original presentation as if no modification was made. It is appreciated that a similar processing to the audio portion may take place with respect to the video portion, using a video processing module (not shown), to identify video portions to be modified and to modify the video portions either automatically or in response to user selection thereof.

It is appreciated that one or more of the data processing module 122, the audio processing module 124, the audio to text module 126, and text processing module 128 may be used to identify a mismatch between one or more of segment (e.g., audio/video of the presenter 102 discussing the second feature while the slide has advance to the third feature) and the transition element (e.g., transition element between the second segment associated with the second feature and the third segment associated with the third feature). As another example, it may be determined that the presenter 102 is still talking about the third feature while the slides have advance to the fourth feature or are showing the second feature or that the presenter 102 is demoing the second feature even though the slide is on the first feature (e.g., first segment). As such, AI/ML may be used (e.g., invoked by a user such as the presenter 102, automatically invoked by the processor 170, etc., to identify mismatch associated with audio/video of the presenter 102 or audience and the content being presented (e.g., from the slide, from the file being share, etc.) and may automatically modify the content to address the mismatch. For example, if the presenter 102 is discussing the second feature (i.e., second segment) but the slides have advance to the third feature (i.e., third segment), then AI may modify the content to extend the second segment (rendering the slide on the second segment longer than it was originally) and move the transition element out until the presenter 102 is done with the second segment before it is transitioned, using a transition element, into the next segment (e.g., third segment). In yet another example, the identified mismatch may be presented to a user, via the input/output device 140, to allow the user to take appropriate steps, e.g., modifying the content or having AI/ML modify the content. Accordingly, portions of the input data 112 that may benefit from being modified or replaced may be identified and ultimately modified or replaced. As such, the presentation becomes more appealing and effective.

It is appreciated that AI/ML may suggest video clips, once edits to the content is complete. The video clips may be a compilation of content presented on (after edits) that may be used for marketing purposes or to provide a short trailer associated with the presentation to get more subscribers to the presentation or webcast. The video clip may be AI generated in some nonlimiting examples. The video clips may include a short summary associated with the presentation as a whole or a short synopsis associated with one or more segments.

In one nonlimiting example, the transcription of the content (after edits are made) may be translated to other languages, using an automatic translation module 150. In one nonlimiting example, the user may use the input/output device 140 to identify the language that the content is to be translated to. It is appreciated that the translation may be with respect to one or more textual content and audio content. It is appreciated that in some embodiments, the translation occurs automatically and without user selection thereof.

It is appreciated that the edited content (the entire presentation after it is edited) may be output as output data 192 and be stored in a storage device, e.g., storage device 190, for later retrieval. It is appreciated that the edited content may include transcripts, subtitles, summary for the segments, and additional topics that may be related to the content that was presented on. In some examples, the generated video clips associated with the presentation may also be stored and may be used for marketing purposes as one example. It is appreciated that the video presentation that has been created may further include metadata. According to some embodiments, the metadata may be extracted from the input data 112 and it may include an engagement score associated with the attendee (e.g., how active the attendee is), a sentiment associated with the attendee (e.g., whether the attendee is frustrated, angree, happy, upset, etc.), questions asked, time distribution on presentation (statistical data associated with amount of time spent on presentation versus answering question as an example), etc. In yet some embodiments, the metadata that is extracted may be associated with the hosts and/or panelists. The metadata may include one or more of sentiment, statistical data associated with talking as opposed to listening ration, talking energy (measure of enthusiasm, speed of presentation, etc.), talking speed (e.g., amount of information covered per unit time), longest monologue (the longest amount of talk by one individual), a number of interruptions (e.g., a number of times the presenter/host has been interrupted during presentation), a number of filler words (as described above), patience (e.g., the amount of time the host/panelists remain quiet for an individual to speak or ask questions or voice concern), engaging questions (the number and/or amount of time for asking questions, time distribution on presentation (statistical data associated with amount of time spent on presentation versus answering question as an example), etc.

Accordingly, the presentation becomes more appealing visually, audibly, as well as becoming more comprehensible by automatically modifying the content while maintaining its flow with the entire presentation by using style and format unit to the presenter 102.

One or more of the modules discussed herein may use ML algorithms or models. In some embodiments, some of the modules of FIG. 1A comprise one or more ML models or implement ML techniques. For instance, any of the modules of FIG. 1A may be one or more of: Voice Activity Detection (VAD) models, Gaussian Mixture Models (GMM), Deep Neural Networks (DNN), Recurrent Neural Network (RNN), Time Delay Neural Networks (TDNN), Long Short-Term Memory (LSTM) networks, Agglomerative Hierarchical Clustering (AHC), Divisive Hierarchical Clustering (DHC), Hidden Markov Models (HMM), Natural Language Processing (NLP), Convolution Neural Networks (CNN), General Language Understanding Evaluation (GLUE), Word2Vec, Gated Recurrent Unit (GRU) networks, Hierarchical Attention Networks (HAN), or any other type of machine learning model. The models listed herein serve as examples and are not intended to be limiting.

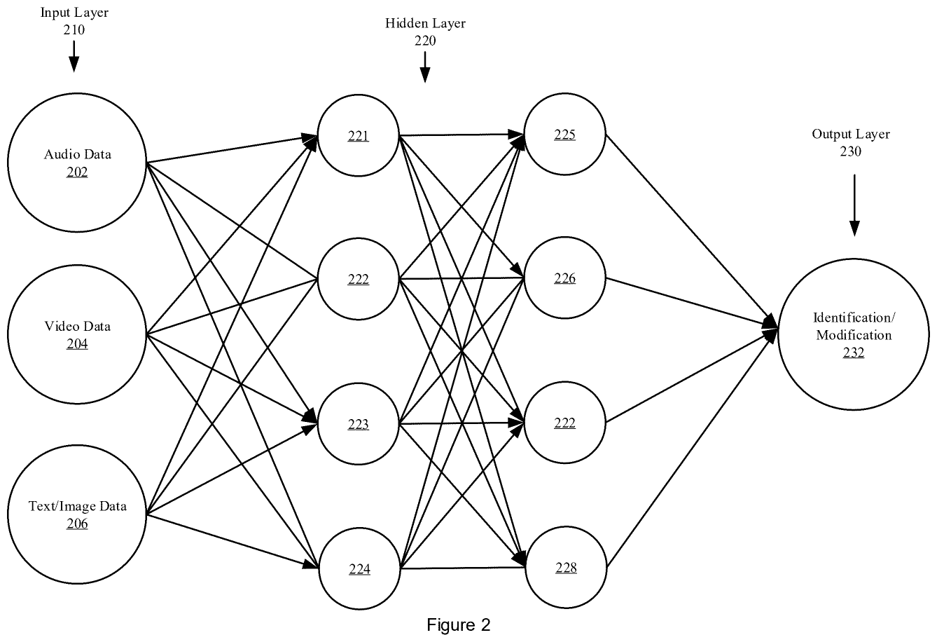

In an embodiment, each of the machine learning models are trained on one or more types of data in order to generate live summaries, to identify segments, to identify transition elements, to identify content to be modified (audio, video, text), etc. Using the neural network 200 of FIG. 2 as an example, a neural network 200 may include an input layer 210, one or more hidden layers 220, and an output layer 230 to train the model to perform various functions in relation to the AI module 130, described in FIG. 1A. In some embodiments, where the training data is labeled, supervised learning is used such that known input data, a weighted matrix, and known output data is used to gradually adjust the model to accurately compute the already known output. In other embodiments, where the training data is not labeled, unsupervised and/or semi-supervised learning is used such that a model attempts to reconstruct known input data over time in order to learn.

Training for example neural network 200 using one or more training input matrices, a weight matrix, and one or more known outputs may be initiated by one or more computers associated with the ML modules. For example, one, some, or all of the modules of FIG. 2 may be trained by one or more training computers, and once trained, used in association with the server and/or client devices to process audio, video, text, images, or any other types of data during a conference session (or webinar) for the purposes of identifying segments, identifying transition elements, modifying segments and/or transition elements, generating new segments and/or new transition elements, modifying audio/video/text, etc., as described in FIG. 1A. In an embodiment, a computing device may run known input data through a deep neural network in an attempt to compute a particular known output. For example, a server uses a first training input matrix and a default weight matrix to compute an output. If the output of the deep neural network does not match the corresponding known output of the first training input matrix, the server may adjust the weight matrix, such as by using stochastic gradient descent, to slowly adjust the weight matrix over time. The server may then re-compute another output from the deep neural network with the input training matrix and the adjusted weight matrix. This process may continue until the computer output matches the corresponding known output. The server may then repeat this process for each training input dataset until a fully trained model is generated.

In the example of FIG. 2, the input layer 210 may include a plurality of training datasets that are stored as a plurality of training input matrices in an associated database. In some embodiments, the training datasets may be updated and the ML models retrained using the updated data. In some embodiments, the updated training data may include, for example, user feedback or other user input.

The training input data may include, for example, audio data 202, video data 204, and/or text/image data 206. In some embodiments, the audio data 202 is any data pertaining to a the presenter speaking or audience speaking or audio within the presentation such as within a slide or video. The video data 204 may be any data pertaining to the video of the presenter during the presentation, video of the audience during the presentation, video included in slides being presented on, etc. The text/image data 206 may be any data pertaining to the content of the slide or document being presented on. While the example of FIG. 2 specifies audio data 202, video data 204, and/or text/image data 206, the types of data are not intended to be limiting. Moreover, while the example of FIG. 2 uses a single neural network, any number of neural networks may be used to train any number of ML models to identify segments, identify transition elements, identify content to modify, modify content or segment or the transition element, etc.

In the embodiment of FIG. 2, hidden layers 220 may represent various computational nodes 221, 222, 223, 224, 225, 226, 227, 228. The lines between each node 221, 222, 223, 224, 225, 226, 227, 228 may represent weighted relationships based on the weight matrix. As discussed above, the weight of each line may be adjusted overtime as the model is trained. While the embodiment of FIG. 2 features two hidden layers 220, the number of hidden layers is not intended to be limiting. For example, one hidden layer, three hidden layers, ten hidden layers, or any other number of hidden layers may be used for a standard or deep neural network. The example of FIG. 2 may also feature an output layer 230 with an identification/modification 232 as the output. The identification/modification 232 may be one or more identification of segments, transition elements, identification of content to modify, modification to content, etc., as described in FIG. 1A. As discussed above, in this structured model, the identification/modification 232 may be used as a target output for continuously adjusting the weighted relationships of the model. When the model successfully outputs an accurate identification/modification 232, then the model has been trained and may be used to process live or field data.

Once the neural network 200 of FIG. 2 is trained, the trained model may accept field data at the input layer 210, such as audio data 202, video data 204, text/image data 206 or any other types of data from current conferencing session or webinar session. In some embodiments, the field data is live data that is accumulated in real time, such as during a live audio-video conferencing session or live webinar session. In other embodiments, the field data may be current data that has been saved in an associated database. The trained model may be applied to identify segments, identify transition elements, identify content/transition element/segment to modify, modify content/transition element/segment, etc., at the output layer 230.

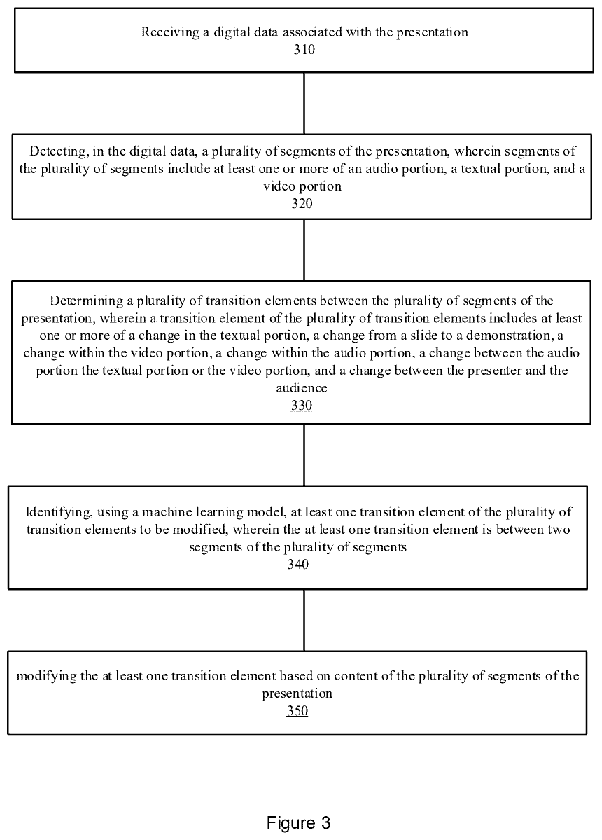

FIG. 3 is a flowchart depicting editing a presentation being made between a presenter and an audience, in an example embodiment. At step 310, a digital data associated with the presentation is received, as described in FIG. 1A. Referring to 1B the digital data may be represented by the recording 193, which in this example is a video recording.

At step 320, a plurality of segments of the presentation is detected (identified), as described above and as shown in FIG. 1B, using one or more clustering algorithms or NLP. It is appreciated that the segments of the plurality of segments include at least one or more of an audio portion, a textual portion, and a video portion. Referring to FIG. 1B, the segments 194 are identified in user interface. According to some embodiments, a user may manually edit/trim segments by manipulating the segment element by sliding the right/left edge of element to make it either larger or smaller. The system reflects manual edits by updating the portion of the transcript text 198 associated with the segments 194. For instance, if the user trimmed a few seconds from the first segement of segments 194 (that includes four segments) the highlighted portion of the transcript text 198 is also modified to reflect the new segment. According to some embodiments, the chapters 195 may also be automatically updated based on the user manipulation of the segments, as described above.

At step 330, a plurality of transition elements between the plurality of segments of the presentation is determined (identified), as described in FIG. 1A, using the same or a different ML model as that for detecting the segments. It is appreciated that a transition element of the plurality of transition elements includes at least one or more of a change in the textual portion, a change from a slide to a demonstration, a change within the video portion, a change within the audio portion, a change between the audio portion the textual portion or the video portion, and a change between the presenter and the audience. It is appreciated that a transition element may be content positioned between two segments, e.g., two subsequent/adjacent segments. Referring back to FIG. 1B, the transition elements 196 positioned between the segments 194 are idetnfied

At step 340, at least one transition element of the plurality of transition elements to be modified is identified using a machine learning model, as described in FIG. 1A. It is appreciated that the at least one transition element is between two segments of the plurality of segments. For example, transcript text 198 may be highlighted as an element to be automatically modified.

At step 350, the at least one transition element based on content of the plurality of segments of the presentation is modified, as described in FIG. 1A. It is appreciated that modifying the transition element may be in response to a user selection or indication thereof after the transition element(s) is flagged and rendered to the user as a transition element to be modified. In an example, one or more of the transition elements 196 may be manipulated to modify segments 194, e.g., lengethening or shortening a segment within segments 194. Manipulation of the transition elements 196 may be automatic or in response to a user manipulation. As such, modifications made to one or more of segments 194 and transition elements 196 results in changes to be made to chapters 195, video display 197, and/or the transcription text 198.

It is appreciated the modification of the transition element based on content of the plurality of segments of the presentation includes generating a new transition element based on content segments of the two segments and replacing the at least one transition element with the new transition element. According to some embodiments, the new transition element includes at least one or more of an audio portion, a video portion, and a textual portion.

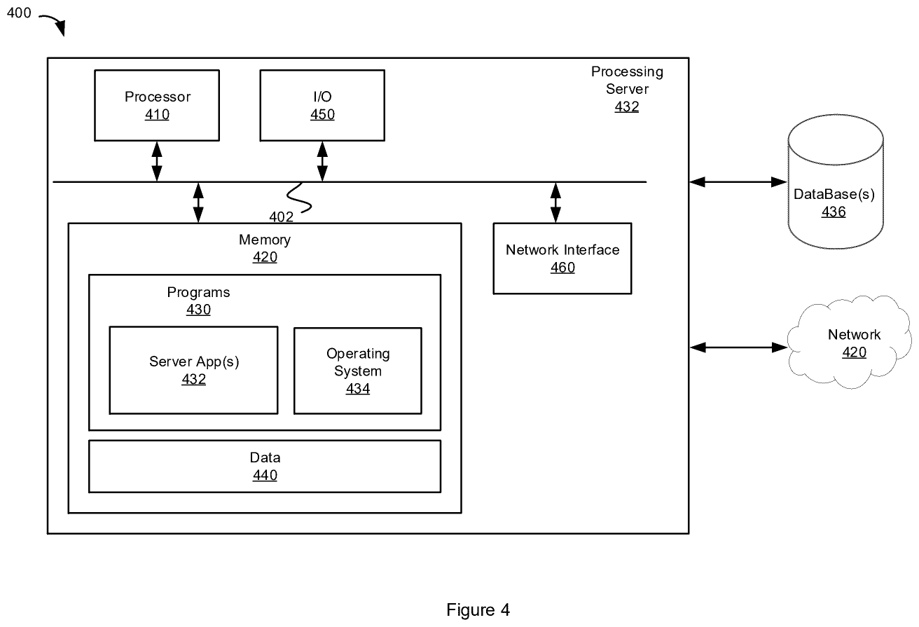

FIG. 4 shows a diagram 400 of an example of a processing server 432, consistent with the disclosed embodiments. The processing server 432 may include a bus 402 (or other communication mechanism) which interconnects subsystems and components for transferring information within the processing server 432. As shown, the processing server 432 may include one or more processors 410, input/output (“I/O”) devices 450, network interface 460 (e.g., a modem, Ethernet card, or any other interface configured to exchange data with a network), and one or more memories 420 storing programs 430 including, for example, server app(s) 432, operating system 434, and data 440, and can communicate with an external database 436 (which, for some embodiments, may be included within the processing server 432). The processing server 432 may be a single server or may be configured as a distributed computer system including multiple servers, server farms, clouds, or computers that interoperate to perform one or more of the processes and functionalities associated with the disclosed embodiments.

The processor 410 may be one or more processing devices configured to perform functions of the disclosed methods, such as a microprocessor manufactured by Intel™ or manufactured by AMD™. The processor 410 may comprise a single core or multiple core processors executing parallel processes simultaneously. For example, the processor 410 may be a single core processor configured with virtual processing technologies. In certain embodiments, the processor 410 may use logical processors to simultaneously execute and control multiple processes. The processor 410 may implement virtual machine technologies, or other technologies to provide the ability to execute, control, run, manipulate, store, etc. multiple software processes, applications, programs, etc. In some embodiments, the processor 410 may include a multiple-core processor arrangement (e.g., dual, quad core, etc.) configured to provide parallel processing functionalities to allow the processing server 432 to execute multiple processes simultaneously. It is appreciated that other types of processor arrangements could be implemented that provide for the capabilities disclosed herein.

The memory 420 may be a volatile or non-volatile, magnetic, semiconductor, tape, optical, removable, non-removable, or other type of storage device or tangible or non-transitory computer-readable medium that stores one or more program(s) 430 such as server apps 432 and operating system 434, and data 440. Common forms of non-transitory media include, for example, a flash drive a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The processing server 432 may include one or more storage devices configured to store information used by processor 410 (or other components) to perform certain functions related to the disclosed embodiments. For example, the processing server 432 includes memory 420 that includes instructions to enable the processor 410 to execute one or more applications, such as server apps 432, operating system 434, and any other type of application or software known to be available on computer systems. Alternatively, or additionally, the instructions, application programs, etc. are stored in an external database 436 (which can also be internal to the processing server 432) or external storage communicatively coupled with the processing server 432 (not shown), such as one or more database or memory accessible over the network 420.

The database 436 or other external storage may be a volatile or non-volatile, magnetic, semiconductor, tape, optical, removable, non-removable, or other type of storage device or tangible or non-transitory computer-readable medium. The memory 420 and database 436 may include one or more memory devices that store data and instructions used to perform one or more features of the disclosed embodiments. The memory 420 and database 436 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, the processing server 432 may be communicatively connected to one or more remote memory devices (e.g., remote databases (not shown)) through network 420 or a different network. The remote memory devices can be configured to store information that the processing server 432 can access and/or manage. By way of example, the remote memory devices could be document management systems, Microsoft SQL database, SharePoint databases, Oracle™ databases, Sybase™ databases, or other relational databases. Systems and methods consistent with disclosed embodiments, however, are not limited to separate databases or even to the use of a database.

The programs 430 may include one or more software modules causing processor 410 to perform one or more functions of the disclosed embodiments. Moreover, the processor 410 may execute one or more programs located remotely from one or more components of the processor 170. For example, the processing server 432 may access one or more remote programs that, when executed, perform functions related to disclosed embodiments.

In the presently described embodiment, server app(s) 432 causes the processor 410 to perform one or more functions of the disclosed methods. For example, the server app(s) 432 may cause the processor 410 to analyze different types of audio communications to separate multiple speakers from the audio data and send the separated speakers to one or more users in the form of transcripts, closed-captioning, speaker identifiers, or any other type of speaker information. In some embodiments, other components of the processor 170 may be configured to perform one or more functions of the disclosed methods.

In some embodiments, the program(s) 430 may include the operating system 434 performing operating system functions when executed by one or more processors such as the processor 410. By way of example, the operating system 434 may include Microsoft Windows™, Unix™, Linux™, Apple™ operating systems, Personal Digital Assistant (PDA) type operating systems, such as Apple iOS, Google Android, Blackberry OS, Microsoft CE™, or other types of operating systems. Accordingly, disclosed embodiments may operate and function with computer systems running any type of operating system 434. The processing server 432 may also include software that, when executed by a processor, provides communications with network 420 through the network interface 460 and/or a direct connection to one or more client devices.

In some embodiments, the data 440 includes, for example, audio data, which may include silence, sounds, non-speech sounds, speech sounds, or any other type of audio data.

The processing server 432 may also include one or more I/O devices 450 having one or more interfaces for receiving signals or input from devices and providing signals or output to one or more devices that allow data to be received and/or transmitted by the processing server 432. For example, the processing server 432 may include interface components for interfacing with one or more input devices, such as one or more keyboards, mouse devices, and the like, that enable the processing server 432 to receive input from an operator or administrator (not shown).

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A computer-implemented method for editing a presentation being made between a presenter and an audience, the method comprising:
receiving a digital data associated with the presentation;
detecting, in the digital data, a plurality of segments of the presentation, wherein segments of the plurality of segments include at least one or more of an audio portion, a textual portion, and a video portion;
determining a plurality of transition elements between the plurality of segments of the presentation, wherein a transition element of the plurality of transition elements represents a period of time between two consecutive segments;
identifying, using a machine learning model, at least one transition element of the plurality of transition elements to be modified, wherein the at least one transition element is between two segments of the plurality of segments; and
modifying the at least one transition element based on content of the plurality of segments of the presentation.

2. The computer-implemented method of claim 1, wherein the modifying the at least one transition element based on content of the plurality of segments of the presentation comprises:
generating a new transition element based on content segments of the two segments; and
replacing the at least one transition element with the new transition element.

3. The computer-implemented method of claim 2, wherein the new transition element includes at least one or more of an audio portion, a video portion, and a textual portion.

4. The computer-implemented method of claim 1 further comprising applying another machine learning model to determine the plurality of transition elements.

5. The computer-implemented method of claim 1, wherein the plurality of segments is detected by applying a clustering algorithm to the digital data.

6. The computer-implemented method of claim 1, wherein the plurality of segments is detected by applying a natural language processing (NLP) to the digital content.

7. The computer-implemented method of claim 1, wherein the modifying comprises modifying at least one or more of a textual portion, or a video portion, or an audio portion, of a content of the at least one transition element.

8. The computer-implemented method of claim 1, wherein the identifying the at least one transition element or the modifying the at least one transition element is in response to a user indication thereof.

9. The computer-implemented method of claim 8 further comprising rendering the plurality of segments and the plurality of transition elements to the user prior to the user indication thereof.

10. A system for editing a presentation, comprising:
a processor; and
a memory, storing a set of instructions, that when executed by the processor, causes:
receiving a digital data associated with the presentation;
detecting, in the digital data, a plurality of segments of the presentation, wherein segments of the plurality of segments include at least one or more of an audio portion, a textual portion, and a video portion;
determining a plurality of transition elements between the plurality of segments of the presentation, wherein a transition element of the plurality of transition elements represents a period of time between two consecutive segments;
identifying, using a machine learning model, at least one transition element of the plurality of transition elements to be modified, wherein the at least one transition element is between two segments of the plurality of segments; and
modifying the at least one transition element based on content of the plurality of segments of the presentation.

11. The system of claim 10, wherein the modifying the at least one transition element based on content of the plurality of segments of the presentation comprises:
generating a new transition element based on content segments of the two segments; and
replacing the at least one transition element with the new transition element.

12. The system of claim 11, wherein the new transition element includes at least one or more of an audio portion, a video portion, and a textual portion.

13. The system of claim 10, wherein the instructions when executed by the processor further causes applying another machine learning model to determine the plurality of transition elements.

14. The system of claim 10, wherein the plurality of segments is detected by applying a clustering algorithm to the digital data.

15. The system of claim 10, wherein the plurality of segments is detected by applying a natural language processing (NLP) to the digital content.

16. The system of claim 10, wherein the modifying comprises modifying at least one or more of a textual portion, or a video portion, or an audio portion, of a content of the at least one transition element.

17. The system of claim 10, wherein the identifying the at least one transition element or the modifying the at least one transition element is in response to a user indication thereof.

18. The system of claim 17 further comprising rendering the plurality of segments and the plurality of transition elements to the user prior to the user indication thereof.

19. A non-transitory, computer-readable medium storing a set of instructions that, when executed by a processor, cause:
receiving a digital data associated with the presentation;
detecting, in the digital data, a plurality of segments of the presentation, wherein segments of the plurality of segments include at least one or more of an audio portion, a textual portion, and a video portion;
determining a plurality of transition elements between the plurality of segments of the presentation, wherein a transition element of the plurality of transition elements represents a period of time between two consecutive segments;
identifying, using a machine learning model, at least one transition element of the plurality of transition elements to be modified, wherein the at least one transition element is between two segments of the plurality of segments; and
modifying the at least one transition element based on content of the plurality of segments of the presentation.

20. The non-transitory, computer-readable medium of claim 19, wherein the modifying the at least one transition element based on content of the plurality of segments of the presentation comprises:
generating a new transition element based on content segments of the two segments; and replacing the at least one transition element with the new transition element.
